(19) United States
(12) Patent Application Publication
(10) Pub. No.: US 2021/0315248 A1
(43) Pub. Date: Oct. 14, 2021

(54) SYSTEM AND METHOD FOR HOVENIA DULCIS EXTRACTION

(71) Applicant: 82 Labs Inc., Los Angeles, CA (US)

(72) Inventor: Fu Chen, Hacienda Heights, CA (US)

(73) Assignee: 82 Labs Inc., Los Angeles, CA (US)

(21) Appl. No.: 16/846,072

(22) Filed: Apr. 10, 2020

(51) Int. Cl. A23L 33/105; A23L 2/56

(52) U.S. Cl. CPC A23L 33/105; A23L 2/56

(57) ABSTRACT

A method of extracting Hovenia dulcis includes crushing Hovenia dulcis to form a crude powder. An ethanol/water solution is used in an extraction tank to create an extracted solution, which is de-colorized using activated carbon. The extracted solution is concentrated and filtered, after which beta-cyclodextrin is added, resulting in a guest/host molecular complex solution. This solution is spray dried, resulting in a DHM rich solution. A beverage additive may include a dihydromyricetin (DHM)/beta-cyclodextrin molecular complex, wherein the DHM/beta-cyclodextrin molecular complex is a guest/host molecular complex, wherein DHM is present in an amount of at least 35 w/w %, and wherein the beverage additive is completely water soluble.

### BACKGROUND

Dihydromyricetin (DHM) is a flavanonol with antioxidant and anti-cancer activity, found to have anti-alcohol intoxication effects. Its anti-alcohol effects appear to be by its actions as a positive modulator of GABA-A receptors at the benzodiazepine site. In some studies, administration of DHM counteracted acute alcohol intoxication, and also withdrawal symptoms including tolerance, increased anxiety and seizure susceptibility. Despite its therapeutic promise, DHM is faced with the problem of low oral bioavailability. The low bioavailability is presumably caused by the combined effects of its low solubility (0.2 mg/mL at 25° C.) and poor permeability (P_{eff}=(1.84±0.37)×10⁻⁶ cm/s). Therefore, a need exists to improve the bioavailability of the DHM.

### BRIEF SUMMARY

A method of extracting Hovenia Dulcis may involve crushing Hovenia Dulcis to form a crude powder. The method may produce at least one batch of an extracted solution from the crude powder by utilizing the ethanol/water solution. The method may pool the extracted solution, resulting in a pooled extracted solution. The method may de-colorize the pooled extracted solution using activated carbon, resulting in a de-colorized solution. The method may concentrate the de-colorized solution, resulting in a concentrated solution. The method may filter the concentrated solution, resulting in a filtered solution. The method may add beta-cyclodextrin to the filtered solution, resulting in a guest/host molecular complex solution. The method may spray dry the guest/host molecular complex solution, resulting in a dihydromyricetin (DHM) rich solution.

A beverage additive comprises an Hovenia dulcis extract including a dihydromyricetin (DHM)/beta-cyclodextrin molecular complex. The dihydromyricetin (DHM)/beta-cyclodextrin molecular complex may be a guest/host molecular complex. The DHM may be present in an amount of at least about 35 w/w %. The beverage additive may be completely water soluble.

A beverage additive prepared by a process may involve crushing Hovenia Dulcis to form a crude powder. The process may produce at least one batch of an extracted solution from the crude powder by utilizing an ethanol/water solution. The process may pool the extracted solution, resulting in a pooled extracted solution. The process may de-colorize the pooled extracted solution using activated carbon, resulting in a de-colorized solution. The process may concentrate the de-colorized solution, resulting in a concentrated solution. The process may filter the concentrated solution, resulting in a filtered solution. The process may add beta-cyclodextrin to the filtered solution, resulting in a guest/host molecular complex solution. The process may spray dry the guest/host molecular complex solution, resulting in a dihydromyricetin (DHM) rich solution.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a chemical structure of an organic molecule 100 corresponding to dihydromyricetin in accordance with one embodiment.

FIG. 2 illustrates chemical structure of organic molecules 200 corresponding to cyclodextrins in accordance with one embodiment.

FIG. 3 illustrates a system 300 in accordance with one embodiment.

FIG. 4 illustrates a method 400 in accordance with one embodiment.

### DETAILED DESCRIPTION

A method of extracting Hovenia dulcis from plant leaves results in a dihydromyricetin rich solution including a DHM/beta-cyclodextrin molecular complex that is surprisingly dissolvable in aqueous solutions, particularly at low temperatures. Additionally, the DHM/beta-cyclodextrin molecular complex used as a beverage additive is able to dissolve faster, even at elevated temperatures, in a beverage or other water-based solution. This may be in part due to the formation of the dihydromyricetin (DHM)/beta-cyclodextrin molecular complex.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

A method of extracting Hovenia dulcis includes crushing Hovenia dulcis to form a crude powder. Any part of the plant may be used, including leaves, fruits, stems, etc. An ethanol/water solution is used in an extraction tank to create an extracted solution, which is de-colorized using activated carbon. The extracted solution is concentrated and filtered after which beta-cyclodextrin is added, resulting in a guest/host molecular complex solution. This solution is spray dried, resulting in a DHM rich solution. For this disclosure, the DHM rich solution may be in any form, such as a dry powder, a moist powder, or a liquid if combined with another liquid solution.

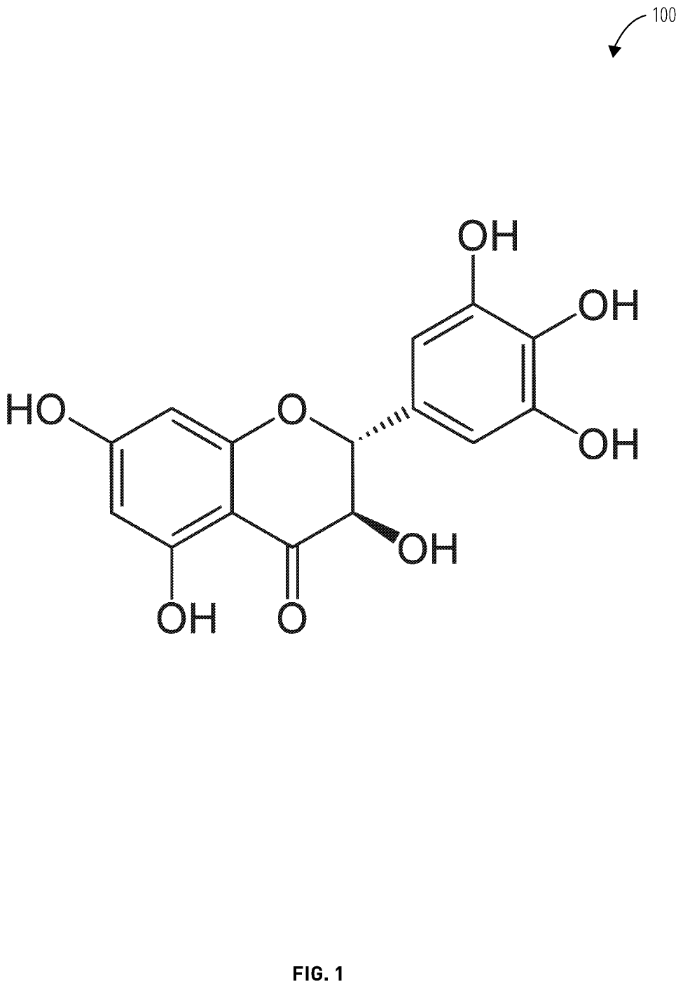

FIG. 1 illustrates a chemical structure of an organic molecule 100 corresponding to dihydromyricetin. Dihydromyricetin (DHM, (2R,3R)-3,5,7-trihydroxy-2-(3,4,5-trihydroxyphenyl)-2,3-dihydrochromen-4-one)) is a flavanonol with antioxidant and anti-cancer activity, found to have anti-alcohol intoxication effects. Its anti-alcohol effects appear to be by its actions as a positive modulator of GABA-A receptors at the benzodiazepine site.

DHM can be found in Japanese Raisin Tree (Hovenia dulcis), Ampelopsis Grossedentata (Snake Wine Vine, also called Vine Tea or Teng Cha in China), the Himilayan Cedar Tree (Cedrus Deodara) or the African Blackwood (Erythrophleum africanum). DHM may be extracted through an ethanol extraction process.

TABLE 1
DHM Solubility in Water

| | |
|---|---|
| Temp (° C.) | Solubility (mg/ml) |

| | | |
|---|---|---|
| 25° | C. | 0.7 |
| 100° | C. | 15.5 |

As seen in Table 1, DHM has a solubility of 0.7 mg/ml at room temperature (−25° C.). However the solubility of DHM improves in hot water (−100° C.) to 16.0 mg/ml.

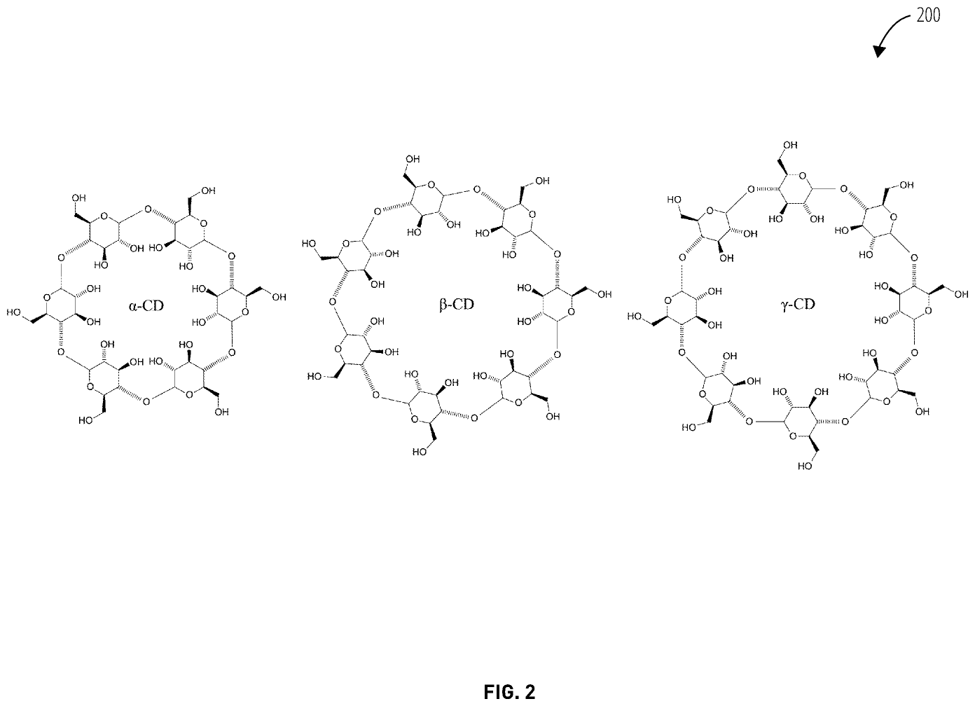

FIG. 2 illustrates chemical structure of organic molecules 200 corresponding to cyclodextrins.

Cyclodextrins are cyclic oligosaccharides with a defined number of d-glucose monomers in the ring. All glucopyranose units are linked by glycosidic α(1→4) bonds.

The three most important cyclodextrins (CDs) consist of 6, 7, or 8 glucose units and are named α-cyclodextrin, β-cyclodextrin, and γ-cyclodextrin, respectively. Higher homologues have been described but have gained no industrial significance up to now.

The three-dimensional structure of cyclodextrins resembles a truncated cone with a hydrophobic cavity. All secondary hydroxyl groups at C2 and C3 are directed towards the wider opening of the cavity, whereas the primary hydroxyl groups at C6 are located on the narrow opening. The C—H groups and a ring of glycosidic oxygen bonds are directed inside the cavity causing its hydrophobic character.

TABLE 2

| | α-Cyclodextrin | β-Cyclodextrin | γ-Cyclodextrin |
|---|---|---|---|
| Formula | C₃₆H₆₀O₃₀ | C₄₂H₇₀O₃₅ | C₄₈H₈₀O₄₀ |
| Molecular mass | 972.85 | 1135.00 | 1297.14 |
| Solubility in water | 14.5 | 1.85 | 23.2 |
| (25° C.), g/100 mL | | | |
| Crystal water, | 10.2 | 13.2-14.5 | 8.13-17.7 |
| wt % | | | |
| α_{D}²⁰, ° | +148 | +162 | +177 |
| mp, ° C. | >200° C. | >200° C. | >200° C. |
| pKₐ value (25° C.) | 12.331 | 12.202 | 12.081 |

Table 2 illustrates the physiochemical properites of cyclodextrins. Cyclodextrins are insoluble in alcohols, ketones, ethers, chlorinated hydrocarbons, and aliphatic and aromatic hydrocarbons.

Cyclodextrins are chiral, nonreducing oligosaccharides. Upon oxidation with periodate the glucose rings are cleaved; neither formic acid nor formaldehyde is produced. The only degradation product of all cyclodextrins in acidic solution is glucose. The hydrolysis rate follows the order γ>β>α. Under acidic conditions cyclodextrins are hydrolyzed more slowly than maltooligosaccharides. The glycosidic bond in cyclodextrins is hydrolyzed by α-amylase but not by β-amylase. The rate of enzymatic hydrolysis is fastest with γ-CD, followed by β-CD and α-CD. All cyclodextrins are very stable and highly soluble in alkaline solution (pH>14). In fact the solubility in water can be highly increased in basic solutions. Under nitrogen atmosphere cyclodextrins are stable up to 250° C.

Substitution of hydrogen of the primary and secondary hydroxyl groups leads to cyclodextrin derivatives. Most reactions are carried out in aqueous solutions. Other suitable solvents are dimethyl sulfoxide, dimethyl formamide, and pyridine.

Cyclodextrins are prepared by enzymatic degradation of starch with cyclodextrin glycosyltransferase (CGTase) at 30-90° C. For industrial production corn and potato starch are most important, but wheat and tapioca starch can also be used. Several microorganisms are able to produce CGTases, for example Bacillus macerans, Bacillus megaterium, Bacillus subtilis, Bacillus firmus, Bacillus circulans, Klebsiella pneumoniae, or Klebsiella oxytoca.

The aqueous solution of starch is converted to cyclodextrins at a temperature of 30-90° C.

Generally, CGTase enzymes produce all three major types of cyclodextrins, depending on the microbiological source of the enzyme and the conversion conditions. To improve the yield and to alter the ratio of the different cyclodextrins obtained, complexing agents (see Table 2) can be added. Most of the complexing agents form insoluble solid complexes with a certain cyclodextrin. The complex formation shifts the reaction equilibrium towards the desired cyclodextrin and the complex can be separated easily from the liquid conversion mixture. For isolation of the cyclodextrins the complex is dissociated by steam distillation or extraction of the complexing agent with an organic solvent.

The yield can be improved further by utilization of specific enzymes. For example, alpha-CGTase produced by Klebsiella oxytoca produces predominantly α-cyclodextrin in the initial phase. For large-scale production of γ-cyclodextrin a specific gamma-CGTase was developed.

The hydrophobic cavity in cyclodextrins is capable to incorporate guest molecules. With this process of molecular encapsulation, a cyclodextrin inclusion complex (adduct, clathrate) is formed. During the association no covalent or ionic bonds are formed. In solution complex formation and dissociation are in a dynamic equilibrium.

For a complex of 1:1 stoichiometry the system can be described in equation 1 as:

$$CD + G {{⇀}^{ Complex association }}_{{↽}_{Complex association}} CD \cdot G \qquad Equation 1$$

The rate constant kₐ for complex association is in the range of 10⁰-10⁸ mol/s. The complex association therefore is usually a fast process, proceeding within milliseconds. The complex formation is an exothermic reaction (ΔH<0). The complex stability decreases with increasing temperature.

An important aspect for the formation of cyclodextrin inclusion complexes is the geometry of the guest molecule. The size of a guest molecule must be compatible with the diameter of the cavity, which is dependent on the number of glucose units in the ring. With larger molecules it has to be taken into consideration that only side groups penetrate into the cyclodextrin cavity. In these cases, also complexes with higher stoichiometries towards cyclodextrins can be formed. The dependence of the ability to form inclusion complexes, as indicated by a “+”, with α-, β-, or γ-cyclodextrin on the size of the guest molecules is depicted in Table 3.

TABLE 3

| Substance | α-CD | β-CD | γ-CD |
|---|---|---|---|
| Xenon | + | − | − |
| Chlorine | + | − | − |
| Bromine | + | + | − |
| Iodine | + | + | + |
| Carbon dioxide | + | − | − |
| Ethylene | + | − | − |
| Propionic acid | + | − | − |
| Butyric acid | + | + | − |
| Cyclohexane | + | + | + |
| Naphthalene | − | + | + |
| Anthracene | − | − | + |

The driving forces for complex formation may include van der Waals forces, hydrophobic interactions, change in solvation energy for both components and, to a lesser extent, hydrogen bonds. The stability of the complex therefore corresponds to the hydrophobic character of the guest molecule. Very polar or ionic molecules may form only weak complexes.

Most preparations of cyclodextrin complexes are carried out in aqueous systems. Complex formation in the absence of a solvent is too slow.

For complexation in a solution, the aqueous solutions of cyclodextrins are agitated with stoichiometric amounts of a guest substance at slightly elevated temperatures (40-60° C.) for several hours. After the equilibrium is reached water can be removed by freeze drying or spray drying. With many hydrophobic compounds and unmodified cyclodextrins insoluble complexes are obtained which can be isolated by filtration. Drying under vacuum is applied to obtain dry complexes. In some cases, the use of polar co-solvents like methanol or ethanol can be of advantage.

For complexation in a suspension, it is not necessary to work with completely dissolved cyclodextrins. Fast complexation can be achieved in stirred aqueous slurries of cyclodextrins and guest substance.

For complexation by kneading, the water content is further reduced so that the mixture of cyclodextrin, guest, and water forms a paste. To complete complexation this paste is kneaded for 30-200 min. Complexation time is usually lower than in the aforementioned methods.

For complexation with a highly soluble cyclodextrin derivatives, concentrated aqueous solutions of cyclodextrins are stirred with an excess of guest substance. In many cases the formed complexes are very soluble so that un-complexed material can be removed by filtration. The complex solutions can be used directly or can be spray dried to obtain a water-soluble powder.

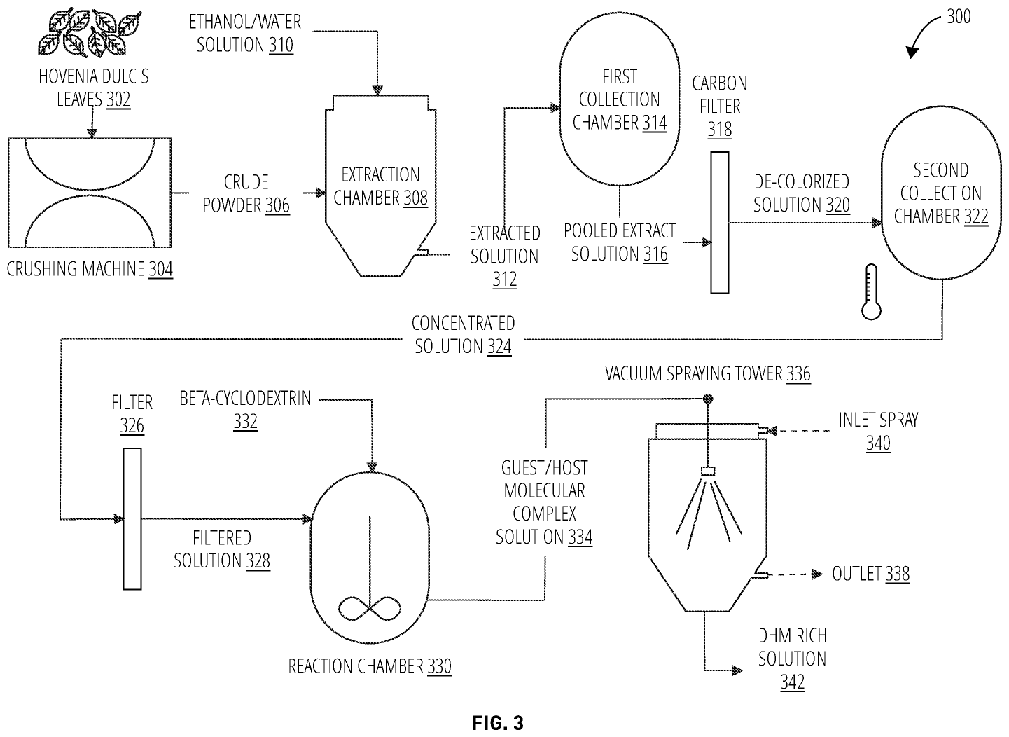

In FIG. 3, a system 300 illustrates an embodiment of a process to produce a DHM rich solution. The system comprises a crushing machine 304, an extraction chamber 308, a first collection chamber 314, a carbon filter 318, a filter 326, a second collection chamber 322, a reaction chamber 330, and a vacuum spraying tower 336.

During operation of the system 300 Hovenia dulcis leaves 302 are fed into a crushing machine 304 that crushes the leaves into a crude powder 306. The crushing machine 304 may crush the leaves into a crude powder 306 with a particle size of 10-20 mesh. Other methods may be used to create the crude powder, such as grinding, blending, chopping, pulverizing, but are not limited thereto. The crude powder 306 is then transferred to the extraction chamber 308 for an extraction process.

During the extraction process, the crude powder 306 is combined with an ethanol/water solution 310 to separate organic compounds based on their solubility with the ethanol/water solution 310. The extraction process may decant the DHM molecules in an extracted solution 312. The extraction process may be repeated several times with the extracted solution 312 being pooled in a first collection chamber 314. In an embodiment, each extraction may take 2 hours to complete. In some configurations of the system, the crude powder 306 may undergo the extraction process three times with each extracted solution 312 being collected in the first collection chamber 314. The ethanol/water solution 310 and the temperature of the extraction chamber 308 may be heated to a temperature ranging between of 40-80° C. In some configurations, temperature of the ethanol/water solution 310 during the extraction may be 60° C. In some configurations, the ethanol/water solution may range from 25:75 w/w % to 75:25 w/w %. In some configurations, the ethanol/water solution 310 may be provided with an ethanol/water solution that is 50:50 w/w %. In other embodiments, the ethanol/water solution may be 40:60 w/w %.

Following the extraction and pooling process, the pooled extract solution 316 may undergo a two step filtration process. The filtration process may begin with the pooled extract solution 316 being passed through a carbon filter 318 comprising activated carbon in order to decolorize the pooled extract solution 316 to produce a de-colorized solution 320. The carbon filter 318 may be an activated carbon filled screen through which the pooled extract solution 316 passes through. As an alternative, activated carbon may be added directly to the pooled extract solution 316. After the addition of activated carbon either by direct addition to the first collection chamber 314 or by the use of the carbon filter 318, the de-colorized solution 320 may be cooled to about 25° C. in the first collection chamber 314 or the second collection chamber 322. The cooling of the pooled extract solution 316 may reduce the solubility of the plant pigments and increase their capture by the activated carbon.

The second collection chamber 322 collects the de-colorized solution 320 and heats the de-colorized solution 320 to evaporate the ethanol to generate a concentrated solution 324. The concentrated solution 324 has a target density of about 1.2 g/ml and is used in the second step of the filtration process, which is filtering the concentrated solution 324 through a filter 326, resulting in a filtered solution 328. The filter 326 may be a screen, but is not limited thereto. The filtered solution 328 is combined with the beta-cyclodextrin 332 in a reaction chamber 330 as part of the complexing step.

In some configurations, the production of the concentrated solution 324 may be considered a filtration step to remove the excess ethanol. The ethanol may be recaptured for use in another extraction process.

With a target density of the concentrated solution 324 at 1.2 g/ml, the process moves on to the complexing step where the filtered solution 328 is combined with beta-cyclodextrin 332 in a reaction chamber 330. The complexing step produces a guest/host molecular complex solution 334 where DHM is complexed with the beta-cyclodextrin, improving the solubility of DHM. In some configurations, the beta-cyclodextrin 332 is added to the filtered solution 328 in an amount in the range of 1-99% w/w. In some configurations, the beta-cyclodextrin is added to the concentrated solution in an amount in the range of 20-30% w/w. In a preferred embodiment, the beta-cyclodextrin is added to the concentrated solution in an amount of 25% w/w.

In some configurations, the complexing step may be modified in accordance with the quantity of the filtered solution 328 and the beta-cyclodextrin 332, as well as the equipment utilized to perform the complexing step. In some configurations, the reaction chamber 330 may be equipped to heat the filtered solution 328 and the beta-cyclodextrin 332, as well as stir the mixture intermittently to improve the rate and likelihood of complexing.

After the guest/host molecular complex solution 334 is produced, the process moves towards a drying process where the guest/host molecular complex solution 334 is dried utilizing a vacuum spraying tower 336. The spray tower is utilized for particle collection by atomizing a solution at a velocity where water droplets and particles separate based on their weight. Any spray drying apparatus known to those of skill in the art may be used, and this disclosure is not limited to spray towers. The vacuum spraying tower 336 may be utilized to collect the guest/host molecular complex of DHM and beta-cyclodextrin as a DHM rich solution 342. The vacuum spraying tower 336 may be configured with an inlet spray 340 and an outlet 338. The inlet spray 340 may be the initial spray of the guest/host molecular complex solution 334 into the vacuum spraying tower 336. The outlet 338 may be the exhaust to remove contents from within the vacuum spraying tower 336. In some instances, the exhaust may be cycled back into the inlet spray 340 to attempt recapturing the target particles. In some configurations of the drying process, the inlet spray 340 may be configured to spray guest/host molecular complex solution 334 at 140° C. while the outlet 338 may be configured at temperature of 85° C. The difference in the inlet spray 340 and outlet 338 temperature may be useful to precipitate the DHM and beta-cyclodextrin complex.

In different configurations of the system 300, the drying process may be modified to accommodate different drying equipment or variations of the vacuum spray drying tower. In these modifications to the drying process may include different temperatures for the inlet spray and the outlet, as well as include criteria for shorter or extended run cycles, spray velocity, to produce the DHM rich solution 342.

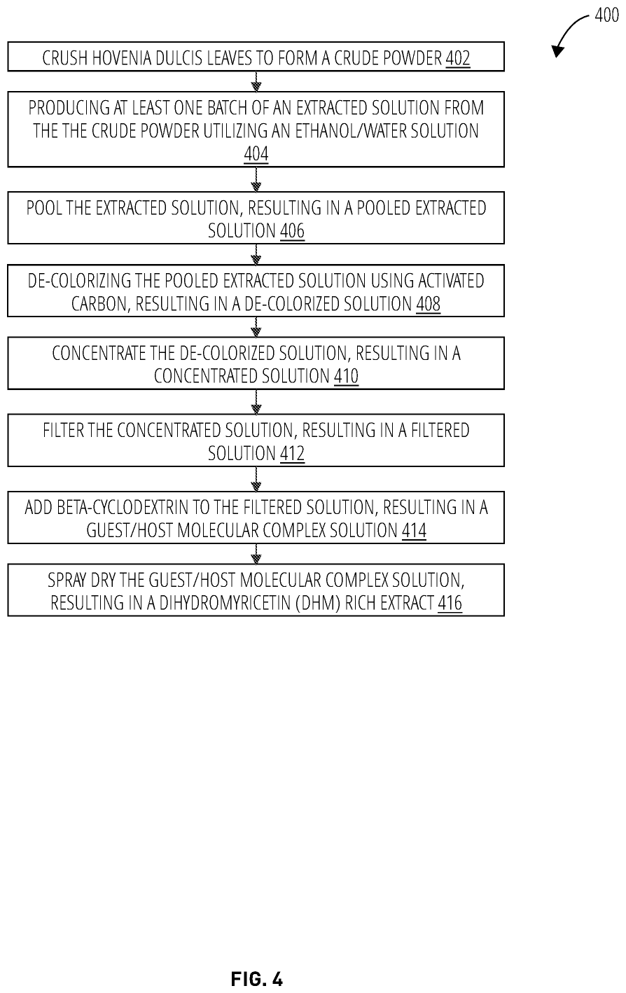

FIG. 4 illustrates a method 400 for producing a DHM rich solution comprising a DHM/beta-cyclodextrin molecular complex. In block 402, the method 400 crushes Hovenia dulcis leaves to form a crude powder. In block 404, the method 400 produces at least one batch of an extracted solution from the crude powder utilizing an ethanol/water solution. In block 406, the method 400 pools the extracted solution, resulting in a pooled extracted solution. In block 408, the method 400 de-colorizes the pooled extracted solution using activated carbon, and results in a de-colorized solution. In block 410, the method 400 concentrates the de-colorized solution, resulting in a concentrated solution. In block 412, the method 400 filters the concentrated solution, resulting in a filtered solution. In block 414, the method 400 adds beta-cyclodextrin to the filtered solution, resulting in a guest/host molecular complex solution. In block 416, the method 400 spray dries the guest/host molecular complex solution, resulting in a dihydromyricetin (DHM) rich solution.

In some configurations, the crude powder is a 10-20 mesh crude powder.

In some configurations, the ethanol/water solution ranges from about 25:75 w/w % to about 75:25 w/w %.

In some configurations method further comprises extracting the crude powder more than one time using the ethanol/water solution. In some configurations, the crude power is extracted three times using the ethanol/water solution.

In some configurations, the process of de-colorizing the pooled extract solution involves the use of an activated carbon filled screen.

In some configurations, the density of the concentrated solution is at least about 1.2 g/ml.

In some configurations, beta-cyclodextrin is added to the filtered solution in an amount in the range of about 1-99% w/w.

In some configurations, beta-cyclodextrin is added to the filtered solution in an amount of about 25% w/w.

In some configurations, the DHM rich solution may comprise DHM in the range of about 5-45% w/w. The DHM rich solution may comprise DHM in any of the following amounts (w/w): at least 5%, at least 10%, at least 15%, at least 20%, at least 25%, at least 30%, at least 35%, or at least 40%. In a preferred configuration, the DHM rich solution may comprise at least 35% w/w DHM.

In some configurations, extracting the crude powder using an ethanol/water solution occurs at a temperature in the range of 40-80° C.

In some configurations, spray drying the guest/host molecular complex solution includes a vacuum spraying tower, wherein the outlet spray temperature is 85° C. and the inlet spray temperature is 140° C.

A beverage additive prepared by a process may involve crushing Hovenia dulcis leaves to form a crude powder. The process may produce at least one batch of an extracted solution from the crude powder by utilizing an ethanol/water solution.

The process may pool the extracted solution, resulting in a pooled extracted solution. The process may de-colorize the pooled extracted solution using activated carbon, resulting in a de-colorized solution. The process may concentrate the de-colorized solution, resulting in a concentrated solution. The process may filter the concentrated solution, resulting in a filtered solution. The process may add beta-cyclodextrin to the filtered solution, resulting in a guest/host molecular complex solution. The process may spray drying the guest/host molecular complex solution, resulting in a dihydromyricetin (DHM) rich solution.

In some configurations, the ethanol/water solution may range from about 25:75 w/w % to about 75:25 w/w %. In some configurations, the beta-cyclodextrin is added to the filtered solution in an amount in the range of about 1-99% w/w.

In some configurations, the beta-cyclodextrin is added to the filtered solution in an amount of about 25% w/w.

In some configurations, the DHM rich solution comprises at least 35% w/w DHM.

The DHM rich solution includes dihydromyricetin (DHM)/beta-cyclodextrin molecular complexes. The dihydromyricetin (DHM)/beta-cyclodextrin molecular complex is a guest/host molecular complex where the solubility characteristics of the beta-cyclodextrin are imparted on DHM within its complex. This complexing of DHM improves solubility and allows the DHM rich solution to be utilized as a beverage additive. In some configurations, the beverage additive may include DHM in an amount of at least 35 w/w %. Due, in part, to the solubility properties of the guest/host molecular complex between DHM and beta-cyclodextrin, the beverage additive is water soluble.

The beverage additive with the DHM/beta-cyclodextrin molecular complex may have better stability in solution under low temperature compared to a beverage that added DHM and beta-cyclodextrin separately. It was observed that a beverage where the DHM and beta-cyclodextrin was added separately would show a build up of sediment after a month of being on a shelf or after the beverage was frozen and thawed. In comparison, a beverage with the beverage additive, where the DHM/beta-cyclodextrin molecular complex was formed before being added to the beverage, showed little to no sedimentation after a month in refrigeration or after 3 freeze/thaw cycles.

Additionally, the DHM/beta-cyclodextrin molecular complex from the beverage additive is able to dissolve faster in a beverage or solution. This was determined by comparing the dissolution of the beverage additive with the DHM/beta-cyclodextrin molecular complex to the dissolution of DHM and beta-cyclodextrin added as individual ingredients to a solution. The experiment was performed where the individual ingredients of beta-cyclodextrin and DHM were added to hot water versus a solution of hot water where the beverage additive was added. The solution where the individual ingredients were added took time to completely dissolve both of the ingredients. In comparison, for the solution with the beverage additive it was noticed that the beverage additive was dissolved almost immediately.

### EXAMPLES

1. Solubility

DHM solubility tests using the methods and solutions in the disclosure were conducted.

To prepare the DHM rich solution, Hovenia dulcis leaves were crushed into 10-20 mesh crude powder using a smashing machine. The crushed raw material was then extracted using ethanol/water (50/50 w/w) for 3 times (2 hours for each extraction) at 60° C. using an extraction tank. The extraction solution was pooled together and de-colorized using active carbon at a temperature below 25° C. The solution was then filtered and concentrated in a concentration tank until density of the concentrate reaches 1.2 g/ml. After that 25% w/w beta-cyclodextrin was added. The mixture was then spray dried immediately in a vacuum spraying tower. The outlet temperature is 85° C. and the inlet temperature is 140° C. during the spray drying.

To prepare the DHM solution without the beta-cyclodextrin, Hovenia dulcis leaves were crushed into 10-20 mesh crude powder using a smashing machine. The crushed raw material was then extracted using ethanol/water (50/50 w/w) for 3 times (2 hours for each extraction) at 60° C. using an extraction tank. The extraction solution was pooled together and de-colorized using active carbon at a temperature below 25° C. The solution was then filtered and concentrated in a concentration tank until density of the concentrate reaches 1.2 g/ml. The solution was then spray dried immediately in a vacuum spraying tower. The outlet temperature is 85° C. and the inlet temperature is 140° C. during the spray drying.

10 g of the DHM rich solution or 10 g of the DHM solution without beta-CD was added in 100 ml of water at 90° C. The mixtures were cooled to room temperature and left under agitation (i.e., magnetic stirring at 100 rpm) overnight. On the next morning, aliquots of both solutions were taken from the bulk solutions and centrifuged to remove insoluble particles, and the DHM concentration in the supernatant of the solution was measured using HPLC.

The solubility of the DHM in the DHM rich solution containing the DHM/beta-cyclodextrin molecular complex was 0.45 g per 100 ml water. Without the addition of beta-cyclodextrin to the DHM compound, the solubility of the DHM was 0.1 g per 100 ml water.

Additionally, the preparation processes described in the disclosure reduce the amount of beta-cyclodextrin needed to solubilize DHM. 1 g of the DHM rich solution was prepared using method disclosed above and added in 90° C. water. The extract was dissolved completely within a few seconds (1 g of DHM rich extract contains 250 mg of beta-cyclodextrin and 350 mg of DHM).

For solubilization of pure DHM, 350 mg of purified DHM (98%) was added in 90° C. water, beta-cyclodextrin was then slowly added to the solution in 500 mg increments until DHM was completely dissolved.

Using the processes disclosed above, only 250 mg of beta-cyclodextrin is needed to solubilize 350 mg DHM. Without these processes, 1.5 g of beta-cyclodextrin is needed to completely solubilize 350 mg of DHM.

2. Stability

Using the processes and compounds in the solubility tests above, 1 g of a DHM rich solution was prepared containing 35% DHM and was added in water at 90° C. and then cooled to room temperature. The solution was frozen and thawed for 3 freeze-thaw cycles. At the end of the 3^{rd} cycle, the solution was visually inspected for sedimentation/participation.

To create the DHM solution solubilized by beta-cyclodextrin, 350 mg of purified DHM (98%) and 1.5 g of beta-cyclodextrin was dissolved in 100 ml of water at 90° C. and left to cool to room temperature.

The test results indicate that the DHM solution was stable, after the freeze-thaw cycles and storage under refrigeration, for up to about 24 months. If DHM is solubilized by beta-cyclodextrin by itself (without going through the process described in this disclosure), it will precipitate, after the freeze-thaw cycle and storage under refrigeration, within about one month.

What is claimed is:

1. A method of extracting Hovenia dulcis, the method comprising:
crushing Hovenia dulcis leaves to form a crude powder;
producing at least one batch of an extracted solution from the crude powder utilizing an ethanol/water solution;
pooling the extracted solution, resulting in a pooled extracted solution;
de-colorizing the pooled extracted solution using activated carbon, resulting in a de-colorized solution;
concentrating the de-colorized solution, resulting in a concentrated solution;
filtering the concentrated solution, resulting in a filtered solution;
adding beta-cyclodextrin to the filtered solution, resulting in a guest/host molecular complex solution;
spray drying the guest/host molecular complex solution, resulting in a dihydromyricetin (DHM) rich solution.

2. The method of claim 1, wherein the crude powder is a 10-20 mesh crude powder.

3. The method of claim 1, wherein the ethanol/water solution ranges from about 25:75 w/w % to about 75:25 w/w %.

4. The method of claim 3, wherein the ethanol/water solution range is about 50:50 w/w %.

5. The method of claim 1, further comprising extracting the crude powder more than one time using the ethanol/water solution.

6. The method of claim 5, wherein the crude powder is extracted three times using the ethanol/water solution.

7. The method of claim 1, wherein de-colorizing the pooled extract solution comprises an activated carbon filled screen.

8. The method of claim 1, wherein the density of the concentrated solution is at least about 1.2 g/ml.

9. The method of claim 1, wherein beta-cyclodextrin is added to the filtered solution in an amount in the range of about 1-99% w/w.

10. The method of claim 9, wherein beta-cyclodextrin is added to the filtered solution in an amount of about 25% w/w.

11. The method of claim 1, wherein the DHM rich solution comprises at least about 35% w/w DHM.

12. The method of claim 1, wherein extracting the crude powder using an ethanol/water solution occurs at a temperature in the range of about 40-80° C.

13. The method of claim 1, wherein spray drying the guest/host molecular complex solution includes a vacuum spraying tower, wherein the outlet spray temperature is 85° C. and the inlet spray temperature is 140° C.

14. A beverage additive comprising:
an Hovenia dulcis extract including:
a dihydromyricetin (DHM)/beta-cyclodextrin molecular complex,
wherein the DHM/beta-cyclodextrin molecular complex is a guest/host molecular complex,
wherein DHM is present in an amount of at least 35 w/w %, and
wherein the beverage additive is completely water soluble.

15. A beverage additive prepared by a process comprising the steps of:
crushing Hovenia dulcis leaves to form a crude powder;
producing at least one batch of an extracted solution from the crude powder by utilizing an ethanol/water solution;
pooling the extracted solution, resulting in a pooled extracted solution;
de-colorizing the pooled extracted solution using activated carbon, resulting in a de-colorized solution;
concentrating the de-colorized solution, resulting in a concentrated solution;
filtering the concentrated solution, resulting in a filtered solution;
adding beta-cyclodextrin to the filtered solution, resulting in a guest/host molecular complex solution;
spray drying the guest/host molecular complex solution, resulting in a dihydromyricetin (DHM) rich solution.

16. The process of claim 15, wherein the ethanol/water solution ranges from about 25:75 w/w % to about 75:25 w/w %.

17. The process of claim 16, wherein the ethanol/water solution range is about 40:60 w/w %.

18. The process of claim 15, wherein beta-cyclodextrin is added to the filtered solution in an amount in the range of about 1-99% w/w.

19. The process of claim 18, wherein beta-cyclodextrin is added to the filtered solution in an amount of about 25% w/w.

20. The process of claim 15, wherein the DHM rich solution comprises at least about 35% w/w DHM.
